(19) United States
(12) Patent Application Publication
(10) Pub. No.: US 2018/0178061 A1
(43) Pub. Date: Jun. 28, 2018

(54) REHABILITATION COMPLIANCE DEVICES

(71) Applicant: CERNER INNOVATION, INC., KANSAS CITY, KS (US)

(72) Inventors: DAVID JOHN O'LARTE, PECULIAR, MO (US); DAVID WILLIAM ALBERS, III, KANSAS CITY, MO (US)

(21) Appl. No.: 15/391,336

(22) Filed: Dec. 27, 2016

(51) Int. Cl. A63B 24/00; G09B 19/00; A63B 21/072

(52) U.S. Cl. CPC A63B 24/0062; G09B 19/003; A63B 21/0726; A63B 2230/06; A63B 2225/15; A63B 2220/40; A63B 2220/803; A63B 2220/836; A63B 2024/0068; A63B 2230/42

(57) ABSTRACT

A tracking and compliance system includes devices to track fitness activity and determine compliance with a rehab program. The tracking and compliance system includes at least one biometric sensor for tracking biometric data from a patient and at least one motion sensor for tracking motion data while a fitness activity is being performed by the patient. The biometric data and motion data are correlated over time to generate activity data for the fitness activity. The activity data can then be compared against a biometric signature for the patient for that type of fitness activity to determine compliance. The biometric signature comprises correlated biometric data and motion data from the fitness activity being previously performed by the patient, for instance, in the presence of a rehabilitation healthcare. A biometric signature can be provided for each of a number of different fitness activities for a given patient.

### BACKGROUND

Rehabilitation healthcare providers, such as physical therapists and athletic trainers, prescribe certain rehab exercises to patients and work with the patients during visits to educate them on how to properly perform the exercises. The patients are then expected to complete those exercises between visits as part of their rehabilitation program. One particular challenge faced by rehabilitation healthcare providers is the lack of some patients' compliance with the exercises. It's difficult for the rehabilitation healthcare providers to ascertain: (1) whether the exercises are actually performed; and (2) if the exercises are performed, whether the exercises are performed correctly. While rehabilitation healthcare providers can pose specific questions and track a patient's progress during visits, this is insufficient to adequately assess the patient's compliance.

### SUMMARY

Embodiments of the present invention relate to, among other things, a tracking and compliance system that includes devices to track fitness activity and determine compliance with a rehab program. The tracking and compliance system includes at least one biometric sensor for tracking biometric data from a patient and at least one motion sensor for tracking motion data while a fitness activity is being performed by the patient. The biometric data and motion data are correlated over time to generate activity data for the fitness activity. The activity data can then be compared against a biometric signature for the patient for that type of fitness activity to determine compliance. The biometric signature comprises correlated biometric data and motion data from the fitness activity being previously performed by the patient, for instance, in the presence of a rehabilitation healthcare. A biometric signature can be provided for each of a number of different fitness activities for a given patient.

Accordingly, in one aspect, an embodiment of the present invention is directed to one or more computer storage media storing computer-useable instructions that, when executed by a computing device, cause the computing device to perform operations. The operations include identifying a type of fitness activity to be performed by a user. The operations also include receiving biometric data from one or more biometric sensors while a user performs the fitness activity. The operations further include receiving motion data from one or more motion sensors while the user performs the fitness activity. The operations also include generating activity data for the fitness activity by correlating the biometric data with the motion data over time. The operations still further include generating compliance data by comparing the activity data for the fitness activity with a biometric signature for the user for the type of fitness activity.

In another embodiment, an aspect is directed to a computer-implemented method. The method includes identifying a type of fitness activity to be performed by a user. The method also includes receiving biometric data with time data, the biometric data from one or more biometric sensors while a user performs the fitness activity. The method also includes receiving motion data with time data, the motion data from one or more motion sensors while the user performs the fitness activity. The method further includes generating activity data for the fitness activity by correlating the biometric data with the motion data using the time data associated with biometric data and the time data associated with the motion data. The method still further includes generating compliance data by comparing the activity data for the fitness activity with a biometric signature for the user for the type of fitness activity.

A further embodiment is directed to a computer system that includes a biometric sensor, a motion sensor, an activity tracking module, and a compliance module. The biometric sensor collects biometric data from a user during a fitness activity. The motion sensor collects motion data during the fitness activity. The activity tracking module generates activity data for the fitness activity using the biometric data from the biometric sensor and the motion data from the motion sensor. The compliance module generates compliance data based on the activity data and a biometric signature for the user for a type of fitness activity corresponding to the fitness activity.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWINGS

The present invention is described in detail below with reference to the attached drawing figures, wherein:

FIG. 1 is a block diagram illustrating components of an exemplary tracking and compliance system in accordance with some implementations of the present disclosure;

FIG. 2 is a block diagram illustrating various devices on which components of an exemplary tracking and compliance system can be implemented in accordance with some implementations of the present disclosure;

FIGS. 3A-3F are block diagrams providing specific examples of different configurations of a tracking and compliance system in accordance with some implementations of the present disclosure;

FIG. 4 is a flow diagram showing a method for generating a biometric signature for a particular fitness activity for a user in accordance with some implementations of the present disclosure;

FIG. 5 is a flow diagram showing a method for generating activity data from a fitness activity performed by a user in accordance with some implementations of the present disclosure;

FIG. 6 is a flow diagram showing a method for determining rehabilitation compliance for a particular fitness activity in accordance with some implementations of the present disclosure; and

FIG. 7 is a block diagram of an exemplary computing environment suitable for use in implementations of the present disclosure.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

As noted in the Background, it's difficult for rehabilitation healthcare providers to determine patients' compliance with rehab exercise programs. While it's possible for rehabilitation healthcare providers to question patients and track progress, such manual assessment is not particularly precise and becomes a bit of a guessing game for the rehabilitation healthcare providers. A potential approach to try to better track patients' exercises would be through the use of “smart” devices. One type of “smart device” is activity trackers, which are commonly used by individuals to monitor fitness-related activities. These include dedicated activity trackers (e.g., the FITBIT activity tracker) as well as smart watches and smartphones with activity tracking capabilities. However, such activity trackers are very limited in the types of activities that can be tracked. Often, they only track number of steps or distance traveled. Therefore, the devices are not useful for other types of activities often used in rehab exercise programs, such as weightlifting or other strength training. Moreover, there's nothing preventing someone else from performing the exercise on behalf of the patient using the patient's activity tracker or the patient from otherwise tricking the activity tracker in believing an activity has been performed (e.g., shaking a step counter to add more steps).

Some “smart” fitness equipment are currently available that allow individuals to identify themselves to the fitness equipment to allow the fitness equipment to track their exercise. For instance, some fitness equipment use a key to identify an individual and track a particular exercise. As with activity trackers, “smart” fitness equipment is limited in the types of activities that can be tracked. Additionally, nothing prevents someone else from performing the exercise for a patient using that patient's key or the patient taking other actions to deceive the system. Moreover, “smart” fitness equipment is not readily available to many patients, who instead use “dumb” fitness equipment (e.g., free weights) with no ability to track fitness activities.

Embodiments of the present invention address the challenge of ensuring compliance with rehab exercise programs by providing a tracking and compliance system that includes devices to track fitness activity and determine compliance with a rehab program. The tracking and compliance system includes at least one biometric sensor for tracking biometric data from a patient while a fitness activity is being performed. The biometrics could include, for instance, heart rate or breathing rate. The tracking and compliance system also includes at least one motion sensor for tracking motion data while a fitness activity is being performed.

Initially, a biometric signature is generated for the patient for a specific fitness activity. A biometric signature comprises correlated biometric data and motion data for a given fitness activity. Each fitness activity has its own biometric signature for a given patient. The biometric signature for a fitness activity could be generated while a rehabilitation healthcare provider observes and instructs the patient on performing the fitness activity correctly.

When the patient subsequently performs a fitness activity, for instance, while at home or otherwise away from the rehabilitation healthcare provide, the tracking and compliance system captures biometric data using the biometric sensor and motion data using the motion sensor. The biometric data and motion data are correlated to generate activity data. The activity data can then be compared against the biometric signature for the patient for that type of fitness activity to determine compliance.

As will be described in further detail below, the devices used to capture the biometric data and motion data can be portable. In some instances, a device is affixed to the patient to collect biometric and/or motion data. In other instances, a device is embedded in or affixed to fitness equipment to collect motion data. If not embedded, the device can be moved from one fitness equipment to another.

Accordingly, embodiments of the present invention provide a solution that addresses the shortcomings of currently available technology, including activity trackers and “smart” fitness equipment. The tracking and compliance system can be used for numerous different types of activities. Additionally, the use of biometric signatures prevents fraud in situations in which another performs exercises for a patient or the patient tries to fake exercise activity. Further, the patient doesn't need access to “smart” fitness equipment. Instead, inexpensive devices can be used that can be placed on the patient and/or fitness equipment. Additionally, the devices can be portable so they can be moved from one piece of fitness equipment to another.

The tracking and compliance system described herein can be used for a number of different purposes. By way of example, the system can be used to record patient compliance to prescribed rehab exercises, detect attempts to cheat or deceive the rehabilitation healthcare provider, provide real-time feedback to the rehabilitation healthcare provider, prevent insurance fraud, provide evidence of correct billing for rehabilitation services, perform timely feedback on whether rehab exercises are being performed correctly (e.g., “you are swinging your leg too fast”), and improve rehab outcomes.

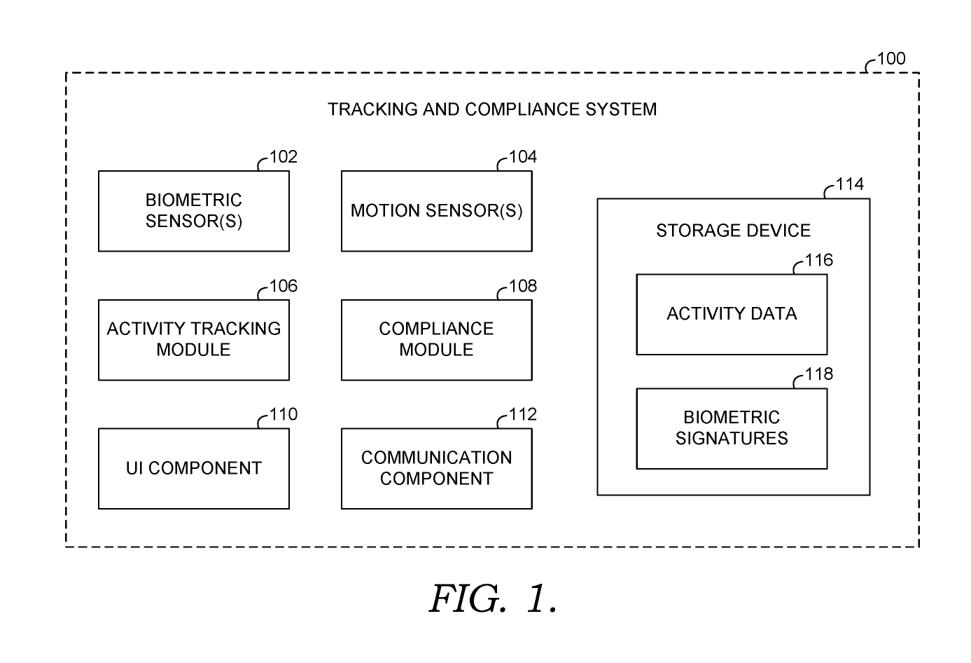

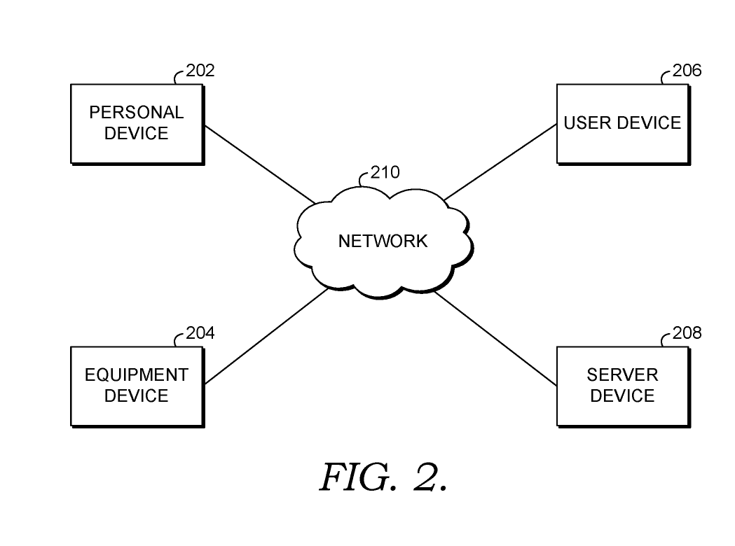

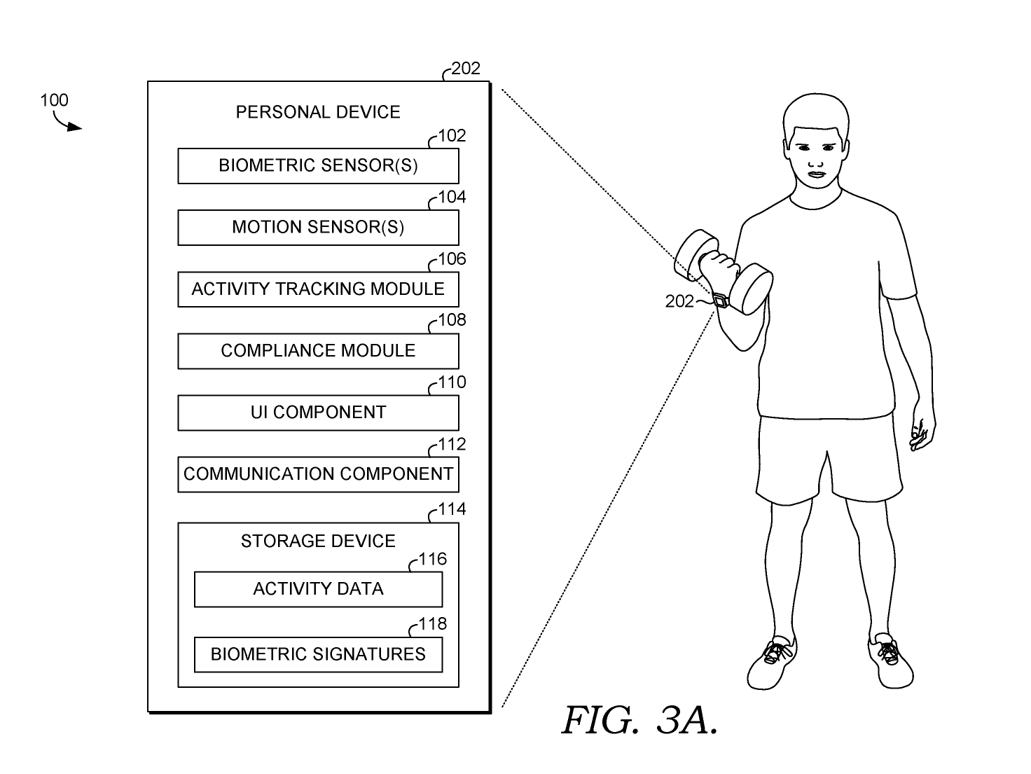

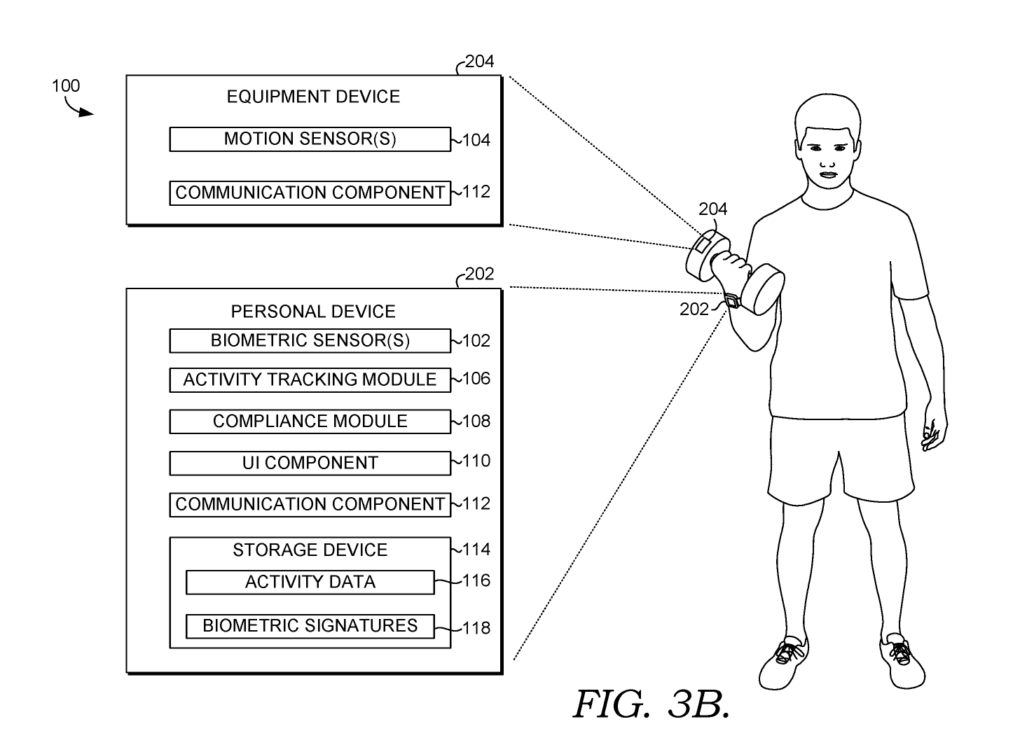

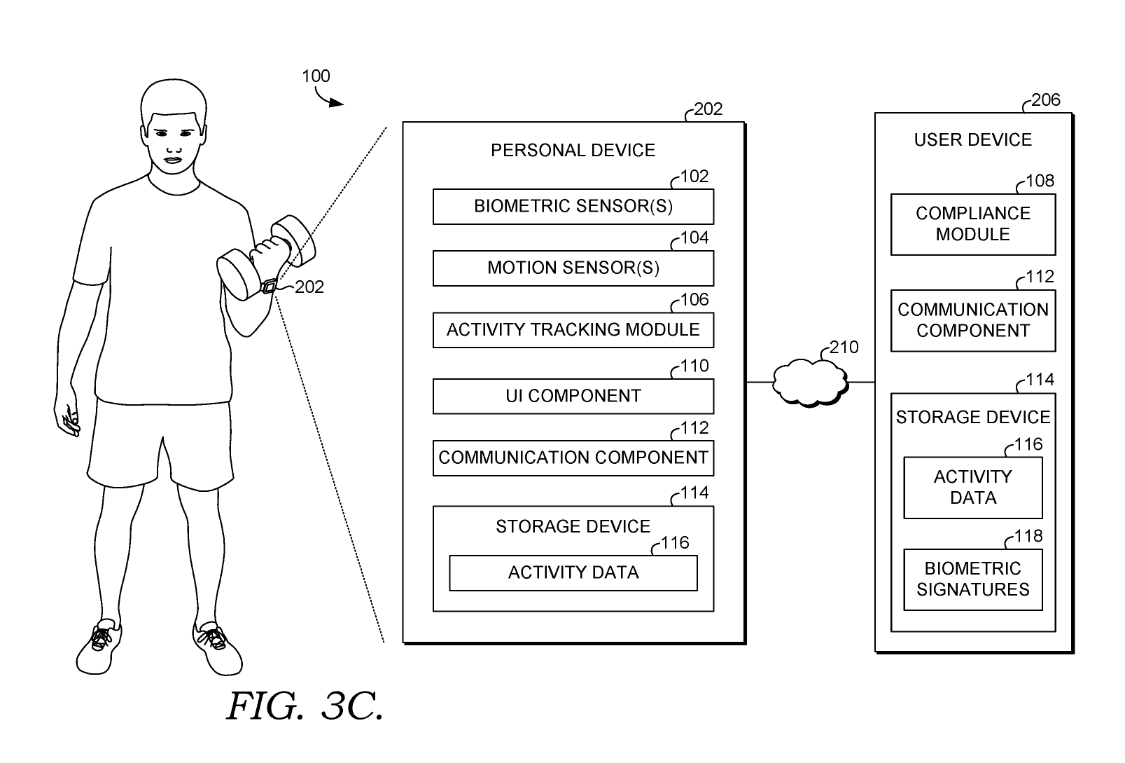

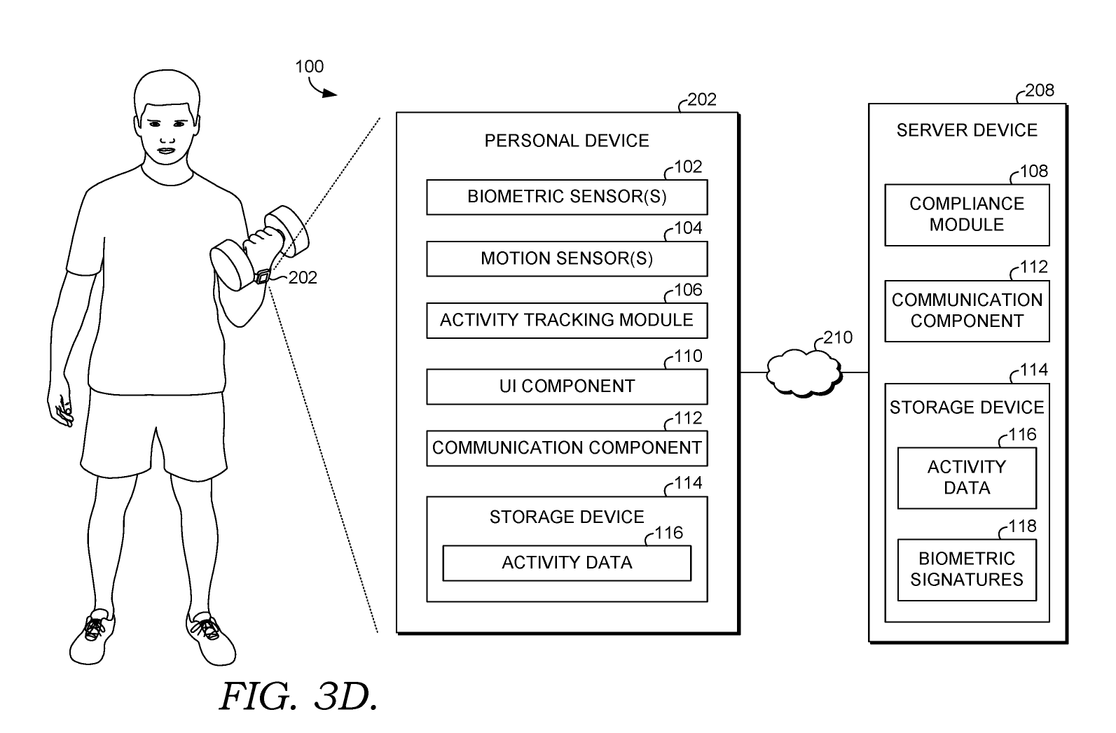

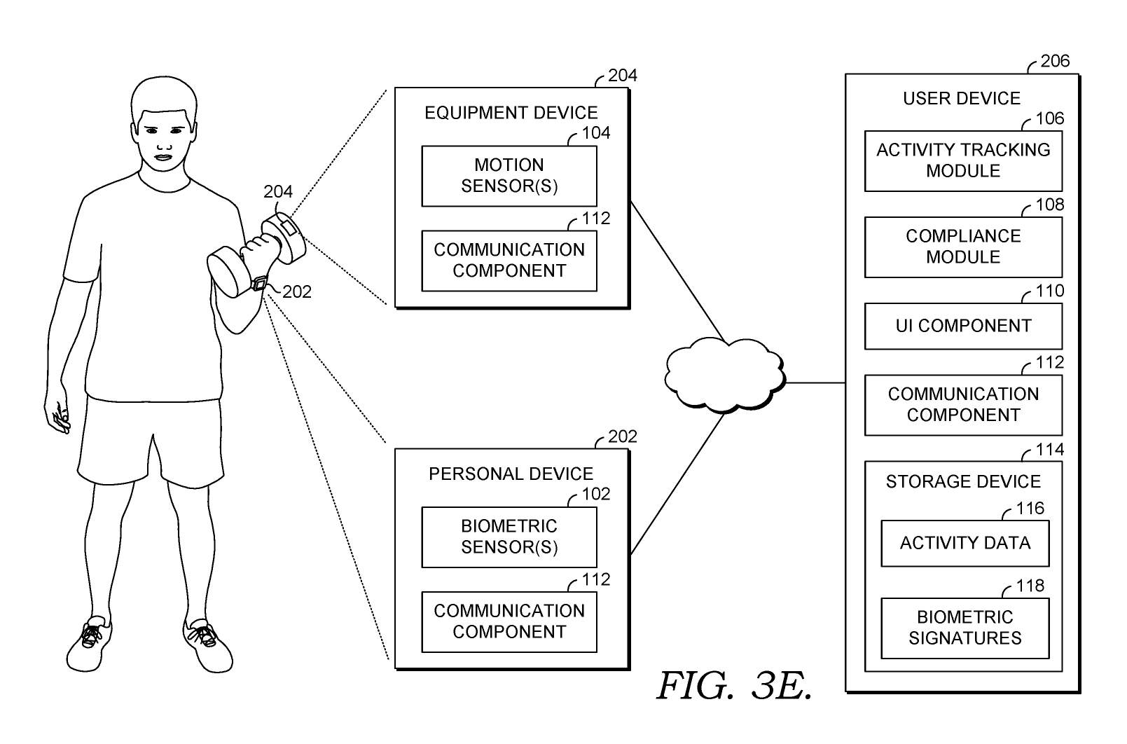

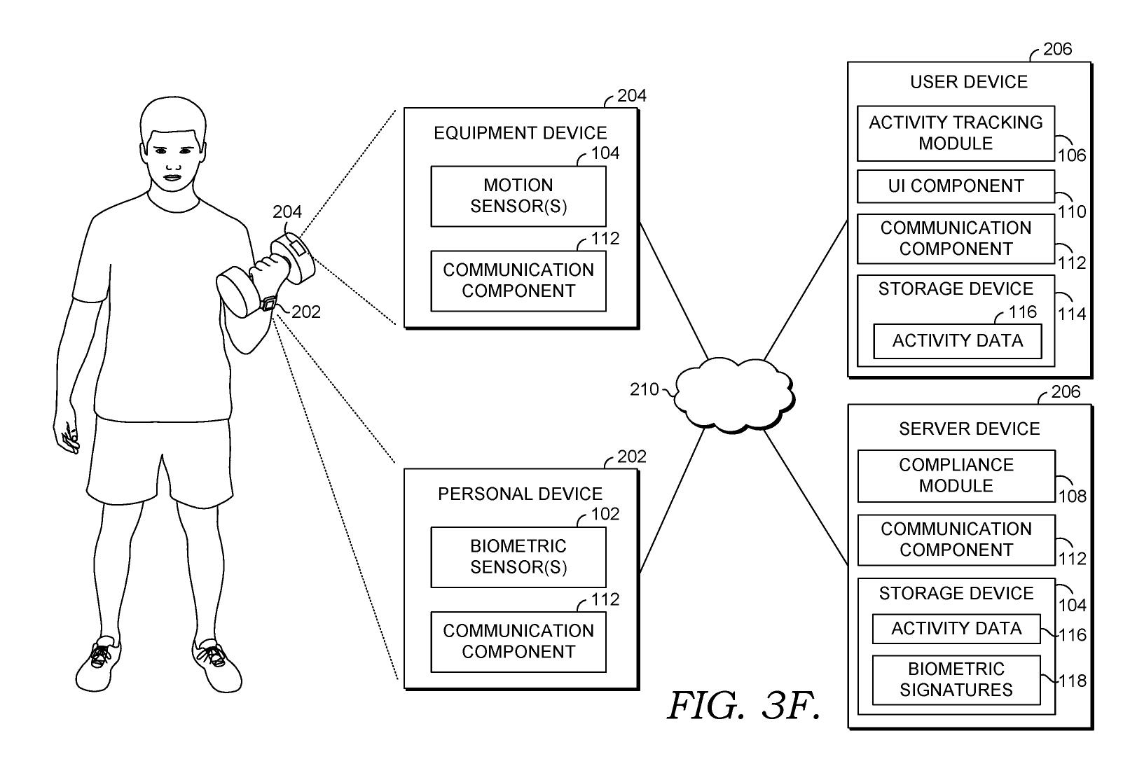

With initial reference to FIG. 1, a block diagram is provided illustrating a tracking and compliance system 100. The tracking and compliance system 100 includes a number of components that operate to track activity data during exercise activities performed by a user and compare the activity data to biometric signatures for the user, as described in further detail herein. Among other components not shown, the tracking and compliance system 100 can include one or more biometric sensor(s) 102, one or more motion sensor(s) 104, an activity tracking module 106, a compliance module 108, a user interface (UI) component 110, a communication component 112, and a storage device 114. As will be described in more detail below with references to examples shown in FIGS. 2 and 3A-3F, the components of the tracking and compliance system 100 can be located on a single device or can be distributed across multiple devices within the scope of embodiments of the present technology.

The one or more biometric sensor(s) 102 track biometrics from the user. In some configurations, a biometric sensor 102 included in the tracking and compliance system 100 is a heart rate monitor that measures the user's heart rate. Known heart rate monitoring technology can be employed. For instance, the heart rate monitor can be a sensor that detects electrical signals (i.e., electrocardiogram signals) transmitted through heart muscle and detected through the user's skin, such as that used in chest strap-type heart rate monitors. As another example, the heart rate monitor can employ optics to measure heart rate based on a temporary darkening due to increased blood amount resulting from a user's pulse. Accordingly, the heart rate monitor can be a sensor that measures an amount of infrared or other light absorbed by blood in order to detect the user's pulse and measure the user's heart rate. These and other heart rate monitors are known to those skilled in the art and therefore will not be discussed in further detail herein.

The one or more biometric sensor(s) 102 can additionally or alternatively include a breathing rate monitor that measures the user's breathing rate. Known breathing rate monitoring technology could be employed. For instance, the breathing rate monitor can be an acoustic sensor that detects the user's breathing rate. As another example, the breathing rate monitor could be a chest or waist strap that measures the user's breathing rate based on girth expansion. Such breathing rate monitors are known to those skilled in the art and therefore will not be discussed in further detail herein.

The one or more motion sensor(s) 104 track movements during exercises. The motion sensor(s) 104 can measure and record, for instance, angular velocity (change in rotational speed), vertical and horizontal accelerations, and g-forces. Any of a variety of motion tracking devices could be employed within the scope of embodiments of the present invention. By way of example only and not limitation, an accelerometer can be used to measure motion via acceleration. As another example, a gyroscope can be used for the determination of orientation and rotation to provide recognition of movement in 3D space (e.g., rotation). In some configurations, an inertial measurement unit (IMU) can be used. It should be understood that multiple types of motion sensors can be employed in conjunction with one another to track motion during fitness activities. These and other motion tracking devices are known to those skilled in the art and therefore will not be discussed in further detail herein.

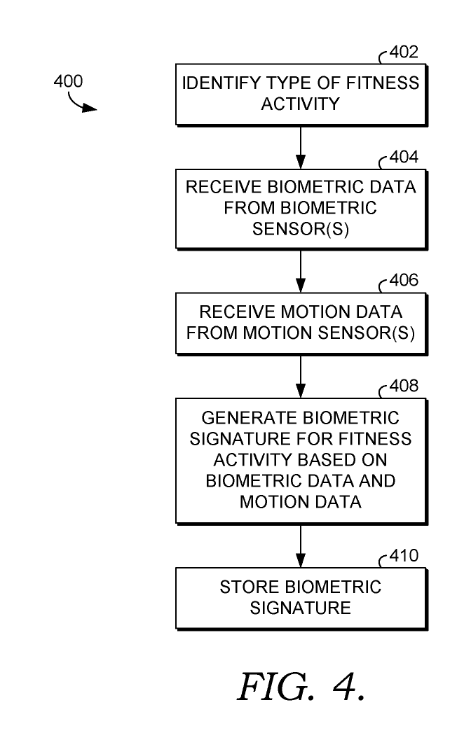

The activity tracking module 106 collects data from fitness activities performed by the user based on biometric data from the biometric sensor(s) 102 and motion data from the motion sensor(s) 104. In some configurations, the activity tracking module 106 is initially used to generate biometric signatures for the user, for instance, using the method 400 discussed below with reference to FIG. 4. As previously discussed, a biometric signature comprises correlated biometric data and motion data for a given fitness activity. Each fitness activity has its own biometric signature for a given user. Biometric signatures 118 may be stored on a storage device 114, as shown in FIG. 1. While the activity tracking module 106 may be used to generate biometric signatures in some configurations, it should be understood that biometric signatures may be generated using other devices and transferred for storage on the storage device 114. For instance, biometric signatures could be generated using devices of a rehabilitation healthcare provider and then stored on the storage device 114.

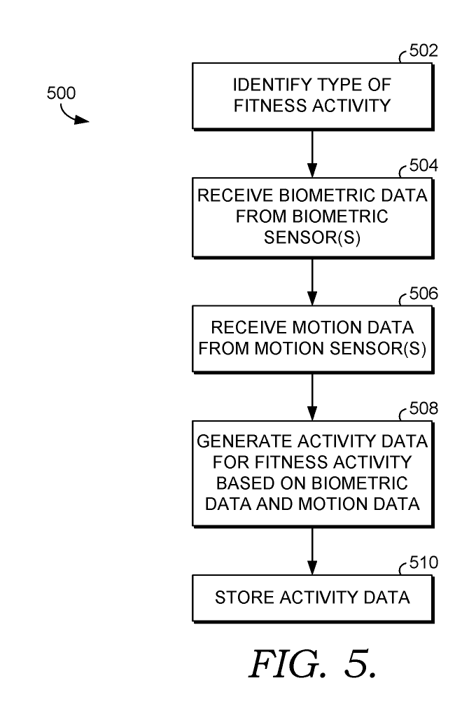

During normal operation, the activity tracking module 106 collects data for fitness activities performed by the user that can then be compared against the user's biometric signatures for those activities. The activity tracking module 106 can collect activity data 116, for instance, using the method 500 described below with reference to FIG. 5. The activity data 116 collected by the activity tracking module 106 can be stored on the storage device 114.

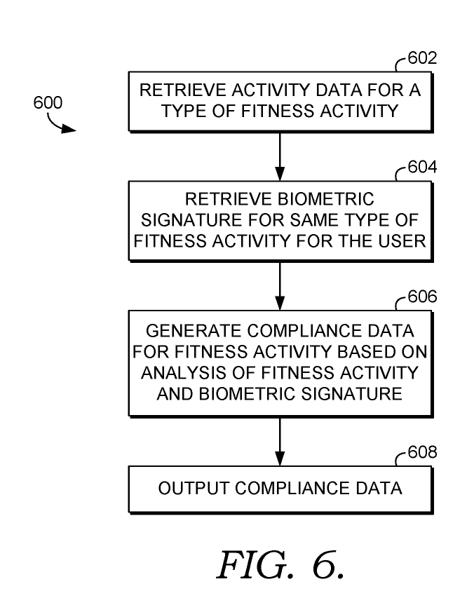

The compliance module 108 compares activity data 116 against biometric signatures 118 for the user. The comparison is specific to a given fitness activity. In particular, activity data 116 for a given fitness activity is compared against a biometric signature 118 for the user for the same fitness activity. The comparison performed by the compliance module 108 can be performed, for instance, user the method 600 described below with reference to FIG. 6.

The UI component 110 includes one or more input/output components that enable the user to interact with the tracking and compliance system 100. For instance, the UI component 110 can be used to input information, such as the type of fitness activity that the user will be performing. The UI component 110 can also be used to output information, such as biometric data, motion data, activity data, biometric signatures, and/or compliance data regarding the comparison of activity data to biometric signatures. The UI component 110 can include, for instance, a touch screen, a display screen and input buttons, or other input/output components such as the input/output components 520 described below with reference to FIG. 5.

The communication component 112 is an interface that allows for communication of data with other devices. This may include the communication of: biometric data from the biometric sensor(s) 102; motion data from the motion sensor(s) 104; biometric signatures; activity data; and/or compliance data. By way of example only and not limitation, the communication component 112 can be a transceiver that wirelessly communicates data with other devices via radio frequency (RF) signals in accordance with any of a number of different wireless technology standards, such as Bluetooth, WiFi, Zigbee, GSM, CDMA, or LTE. The communication component 112 could alternatively be a hardware component that enables wired communication, such as, for instance, a network interface card, an Ethernet port, or a USB port.

As previously noted, the tracking and compliance system 100 can be implemented on a single device or can be distributed across multiple devices. By way of example to illustrate, FIG. 2 illustrates a system with a number of different devices that can be employed to provide the tracking and compliance system 100. The devices include a personal device 202, equipment device 204, user device 206, and a server device 208. Various combinations of the devices shown in FIG. 2 can be employed. When multiple devices are used, the devices can communicate via a network 210, which may include, without limitation, one or more local area networks (LANs) and/or wide area networks (WANs). Such networking environments are commonplace in offices, enterprise-wide computer networks, intranets, and the Internet.

The personal device 202 is a device that is worn by the user. At a minimum, the personal device 202 includes at least one biometric sensor 102 to collect biometric data from the user. The personal device 202 can be worn by the user, for instance, using an adjustable strap or band.

The equipment device 204 is a device that is attached to fitness equipment. At a minimum, the equipment device 204 includes at least one motion sensor 104 to collect motion data during fitness activities. The equipment device 204 can be attached to fitness equipment in any of a variety of different manners. By way of example only and not limitation, the equipment device 204 can be attached to fitness equipment using an adjustable strap or a magnet (e.g., for attaching to equipment made from magnetic metal). In some configurations, a hook-and-loop fastener (e.g., a VELCRO fastener) or a bracket configured to receive the equipment device 204 can be provided on the fitness equipment. In any case, the equipment device 204 can be moved from one fitness equipment to another to allow the user to perform different fitness activities and collect motion data for each of those fitness activities using the equipment device 204.

The user device 206 is a user-owned device, such as the user's smartphone or personal computer. The user device 206 can be owned by the user performing the fitness activity or another person, such as the rehabilitation healthcare provider. In some configurations, the user device 206 can provide the UI component 110 to allow the user to interact with the tracking and compliance system 100. In some configurations, the user device 206 can provide the activity tracking module 106 and/or the compliance module 108. In such configurations, the user device 206 can receive biometric and motion data or activity data from the personal device 202 and/or the equipment device 204 and process the data using the activity tracking module 106 and/or the compliance module 108.

The server device 208 is a remote server that can be configured to provide the activity tracking module 106 and/or the compliance module 108. As such, the server device 208 can receive biometric and motion data or activity data from the personal device 202 and/or the equipment device 204 and process the data using the activity tracking module 106 and/or the compliance module 108.

FIGS. 3A-3F illustrate specific examples of different configurations of the tracking and compliance system 100 using the personal device 202, equipment device 204, user device 206, and/or server device 208. It should be understood that FIGS. 3A-3F are provided by way of example only and not limitation. Other configurations can be used within the scope of embodiments of the present technology.

With initial reference to FIG. 3A, a tracking and compliance system 100 is shown being provided by a single personal device 202 worn by the user. Because the personal device 202 is worn by the user, the personal device 202 can capture biometric data from the user using a biometric sensor 102. Additionally, the personal device 202 is worn at a location on the user's body at which motion data can be captured when the user performs a fitness activity using a motion sensor 104. For instance, FIG. 3A illustrates the personal device 202 worn on the right wrist of the user while the user performs a fitness activity using the user's right arm. The personal device 202 can be moved to other locations on the user's body when the user performs other fitness activities. By way of example and not limitation, the personal device 202 can be moved to: the user's left wrist when the user performs a fitness activity using the user's left arm; the user's right ankle when the user performs a fitness activity using the user's right leg; or the user's left ankle when the user performs a fitness activity using the user's left leg. The personal device 202 can be moved to other locations as well, such as, for instance, the user's upper arms, thighs, chest, or waist, depending on the fitness activity being performed. The personal device 202 can be fixed to the user at the various locations, for instance, using an adjustable strap.

While FIG. 3A illustrates an example with a single personal device 202, in some configurations, multiple personal devices 202 can be employed. For instance, a personal device 202 could be worn on each of the user's wrists. This allows motion data to be simultaneously collected from multiple locations during a fitness activity. Additionally or alternatively, different personal devices 202 can be used to simultaneously collect different biometric data during a fitness activity. For instance, one personal device 202 could collect heart rate data while another personal device collects breathing rate data. The motion and/or biometric data can be communicated from one personal device 202 to another personal device 202 using a communication component 112 on each personal device 202 to allow for analysis of the collected data. For instance, the personal devices 202 can be Bluetooth devices able to wirelessly communicate data via the Bluetooth standard.

FIG. 3B illustrates an example in which a personal device 202 is used to collect biometric data using a biometric sensor 102 and an equipment device 204 is used to collect motion data using a motion sensor 104. In the example shown in FIG. 3B, the personal data 202 includes an activity tracking module 106 and compliance module 108. In such a configuration, motion data is transferred from the equipment device 204 to the personal device 202 using a communication component 112 on each device. This allows for analysis of the biometric and motion data to be performed on the personal device 202 using the activity tracking module 106 and the compliance module 108. It should be understood that in other configurations, the activity tracking module 106 and compliance module 108 could be provided on the equipment device 204, and biometric data could be transferred from the personal device 202 to the equipment device 204 for analysis on the equipment device 204. Likewise, although a UI component 110 is shown only on the personal device 202, in some configurations, the equipment device 204 can include a UI component 110 to allow the user to interact with the tracking and compliance system 100. Additionally, although the personal device 202 is shown without a motion sensor 104, in some configurations the personal device 202 can also include a motion sensor 104 and motion data from the personal device 202 can be correlated to motion data from the equipment device 204. Further, while only a single personal device 202 and a single equipment device 204 is shown in FIG. 3B, it should be understood that any number of personal devices 202 and equipment devices 204 can be employed.

FIG. 3C illustrates an example in which a personal device 202 is employed in conjunction with a user device 206. The personal device 202 includes a biometric sensor 102, a motion sensor 104, and an activity tracking module 104 for capturing biometric and motion data and determining activity data 116. The communication component 112 communicates the activity data 116 to the user device 206, which includes the compliance module 108 and biometric signatures 118. As such, the comparison of activity data 116 to biometric signatures 118 in FIG. 3C is performed by the user device 206. In other configurations, an activity tracking module 106 could also be located on the remote device 206. In such configurations, biometric data from the biometric sensor 102 and motion data from the motion sensor 104 are transmitted from the personal device 202 to the user device 206, which correlates the biometric and motion data using the activity tracking module 106 and compares activity data 116 to biometric signatures 118 using the compliance module 108. Although a UI component 110 is shown only on the personal device 202, in some configurations, the user device 206 can include a UI component 110 to allow the user to interact with the tracking and compliance system 100. Further, while only a single personal device 202 is shown in FIG. 3C, it should be understood that any number of personal device 202 can be employed.

FIG. 3D illustrates a configuration similar to that shown in FIG. 3C except a server device 208 provides a compliance module 108 instead of a user device. In some configurations, the server device 208 also includes an activity tracking module 106.

FIG. 3E illustrates an example in which a personal device 202 provides a biometric sensor 102 to collect biometric data and an equipment device 204 provides a motion sensor 104 to simultaneously collect motion data during a fitness activity. A user device 206 provides a UI component 110 for interacting with the tracking and compliance system 100. Additionally, the user device 206 is configured to receive biometric data from the personal device 202 and motion data from the equipment device 204 via communication components 112 on the devices. The user device 206 correlates the biometric data and motion data using an activity tracking module 106 to generate activity data 116. Additionally, the user device 206 compares the activity data 116 to a biometric signature 118 using a compliance module 108. While only a single personal device 202 and a single equipment device 204 is shown in FIG. 3E, it should be understood that any number of personal devices 202 and equipment devices 204 can be employed. Additionally, while the personal device 202 only includes a biometric sensor 102, the personal device 202 could also include a motion sensor 104.

FIG. 3F illustrates an example configuration similar to that described with reference to FIG. 3E; however, the compliance module 108 is provided on a server device 208 instead of a user device 206. In such a configuration, biometric and motion data are communicated from the personal device 202 and equipment device 204 to the user device 206, which correlates the biometric and motion data using the activity tracking module 106 to generate activity data 116. The activity data 116 is communicated from the user device 206 to the server device 208, which compares the activity data 116 to a biometric signature 118 using the compliance module 108. Compliance data from the comparison could be communicated back from the server device 208 to the user device 206 for display to a user. While only a single personal device 202 and a single equipment device 204 is shown in FIG. 3F, it should be understood that any number of personal devices 202 and equipment devices 204 can be employed. Additionally, while the personal device 202 only includes a biometric sensor 102, the personal device 202 could also include a motion sensor 104.

Turning next to FIG. 4, a flow diagram is provided illustrating a method 400 for generating a biometric signature for a particular fitness activity for a user. Each block of the method 400 and any other method described herein comprises a computing process performed using any combination of hardware, firmware, and/or software. For instance, various functions can be carried out by a processor executing instructions stored in memory. The methods can also be embodied as computer-usable instructions stored on computer storage media. In some configurations, the method 400 can be performed by the activity tracking module 106.

As shown at block 402, a type of fitness activity is initially identified. A fitness activity type may be identified in a variety of different manners in accordance with different configurations of the present technology. For instance, in some configurations, the UI component 110 presents a list of available fitness activities, and the user manually selects a fitness activity from the list. For example, the user could select a fitness activity corresponding with a particular type of curl at a particular weight. In other configurations, fitness equipment can include identification tags that are detected by the UI component 110. For instance, fitness equipment can be tagged with an RFID tag that identifies a specific fitness activity associated with the fitness equipment, and the UI component 110 can include an RFID reader for detecting the RFID tag and thereby identifying a specific fitness activity. As another example, fitness equipment could be tagged with a bar code or QR code that identifies a specific fitness activity, and the UI component 110 could include a camera for detecting the code so the code can be processed to identify the specific fitness activity.

After identifying a particular type of fitness activity, the fitness activity is performed by the user. While the fitness activity is performed by the user, biometric data is received from the biometric sensor(s) 104, as shown at block 404. Additionally, motion data is received from the motion sensor(s) 106, as shown at block 406.

A biometric signature for the identified type of fitness activity is generated for the user based on the biometric data and the motion data, as shown at block 408. The biometric signature is generated by correlating the biometric data to the motion data over time. In particular, the biometric data can comprise a time series of biometric data collected over a time period Likewise, the motion data can comprise a time series of motion data collected over the same or similar time period. The biometric data and motion data each include time data that provides information regarding the timing at which the data was collected. By way of example only and not limitation, the biometric data and motion data can be continuous and the time data can comprise an initial start time and an indication of time lapse over the course of the data. As another example, the biometric data and motion data can comprise data points, each with a corresponding indication of time. Accordingly, to generate the biometric signature, the biometric data and motion data are correlated to one another based on their time data. As such, the biometric signature comprises an indication of the biometric data occurring simultaneously with the motion data over a time period.

By way of example, suppose that only heart rate (biometric) and acceleration (motion) data points are collected. If biometric data was Y, and motion data was X, then using nonlinear regression, a polynomial could be formed which could predict Y given any X. Thus, the polynomial describes the relationship between biometric and motion data. This is only one exemplary approach for deriving the relationship. In some implementations, there can be more attributes to both the biometric data (e.g., respiration, skin conductivity, and electromyography (EMG) measurements) and to the motion data (e.g., altitude and angular velocity). Also note that using nonlinear regression is only one example, and other approaches can be used to correlate the data.

The generated biometric signature is stored, for instance, in a storage device 114, as shown at block 410. The biometric signature is stored with information (e.g., metadata) identifying the specific fitness activity corresponding to the biometric signature. As such, the biometric signature can be used to assess activity data, for instance, using the compliance module 108 as described in further detail below with reference to FIG. 6. The process of the method 400 can be used for various different types of fitness activities for the user to generate a biometric signature for each of the different types of fitness activities for the user.

With reference now to FIG. 5, a flow diagram is provided that illustrates a method 500 for generating activity data from a fitness activity performed by a user. The method 500 may be performed, for instance, by the activity tracking module 106. As shown at block 502, a type of fitness activity is initially identified. As discussed above with reference to FIG. 4, a fitness activity may be identified in any of a number of different manners. For instance, the fitness activity may be identified by the user employing the UI component 110 to select a fitness activity from a list of available fitness activities or detecting an RFID or bar code on fitness equipment.

After a particular type of fitness activity has been identified, the fitness activity is performed by the user. While the fitness activity is performed by the user, biometric data is received from the biometric sensor(s) 104, as shown at block 504. Additionally, motion data is received from the motion sensor(s) 106, as shown at block 506.

Activity data for the fitness activity is generated based on the biometric data and the motion data, as shown at block 508. The activity data is generated similar to the generation of the biometric signature discussed above. In particular, the activity data is generated by correlating the biometric data to the motion data over time. As noted above, the biometric data can comprise a time series of biometric data collected over a time period Likewise, the motion data can comprise a time series of motion data collected over the same or similar time period. The biometric data and motion data each include time data that provides information regarding the timing at which the data was collected. By way of example only and not limitation, the biometric data and motion data can be continuous and the time data can comprise an initial start time and an indication of time lapse over the course of the data. As another example, the biometric data and motion data can comprise data points, each with a corresponding indication of time. Accordingly, to generate the activity data, the biometric data and motion data are correlated to one another based on their time data. As such, the activity data comprises an indication of the biometric data occurring simultaneously with the motion data over a time period.

Similar to the example provided above for biometric signature, suppose that only heart rate (biometric) and acceleration (motion) data points are collected. If biometric data was Y, and motion data was X, then using nonlinear regression, a polynomial could be formed which could predict Y given any X. Thus, the polynomial describes the relationship between biometric and motion data. This is only one exemplary approach for deriving the relationship. In some implementations, there can be more attributes to both the biometric data (e.g., respiration, skin conductivity, and electromyography (EMG) measurements) and to the motion data (e.g., altitude and angular velocity). Also note that using nonlinear regression is only one example, and other approaches can be used to correlate the data.

The activity data is stored, for instance, in a storage device 114, as shown at block 510. The activity data is stored with information (e.g., metadata) identifying the specific fitness activity corresponding to the activity data. As such, the fitness activity can be assessed by comparing the activity data to a biometric signature for the type of fitness activity, for instance, using the compliance module 108 as described in further detail below with reference to FIG. 6. The process of the method 500 can be used for various different types of fitness activities performed by the user to generate activity data for each of the different types of fitness activities performed by the user.

FIG. 6 provides a flow diagram illustrating a method 600 for determining rehabilitation compliance for a particular fitness activity. The method 600 can be performed, for instance, by the compliance module 108. As shown at block 602, activity data for a particular type of fitness activity for a user is retrieved. The activity data may be retrieved, for instance, based on metadata stored with the activity data identifying a type of fitness activity for the activity data. At block 604, a biometric signature for the same type of fitness activity is retrieved from a collection of biometric signatures for the user. The biometric signature may be retrieved, for instance, based on metadata stored with the biometric data identifying a type of fitness activity for the biometric signature.

Compliance data for the fitness activity is generated, as shown at block 606. The compliance data is generated by comparing the activity data against the biometric signature. By way of example to illustrate, each of the activity data and biometric signature comprises biometric data correlated to motion data and each could be represented using a polynomial that describes the relationship between the biometric data and motion data. A statistical approach, such as R-squared can then be used to determine the goodness of fit to the polynomials to determine how well the activity data matched the biometric signature. This is only one exemplary approach for deriving the comparison between the activity data and the biometric signatures, other approaches can be used to make the comparison.

The compliance data is outputted, as shown at block 608. This allows the rehabilitation healthcare provider or another person to review the compliance data for compliance and other purposes.

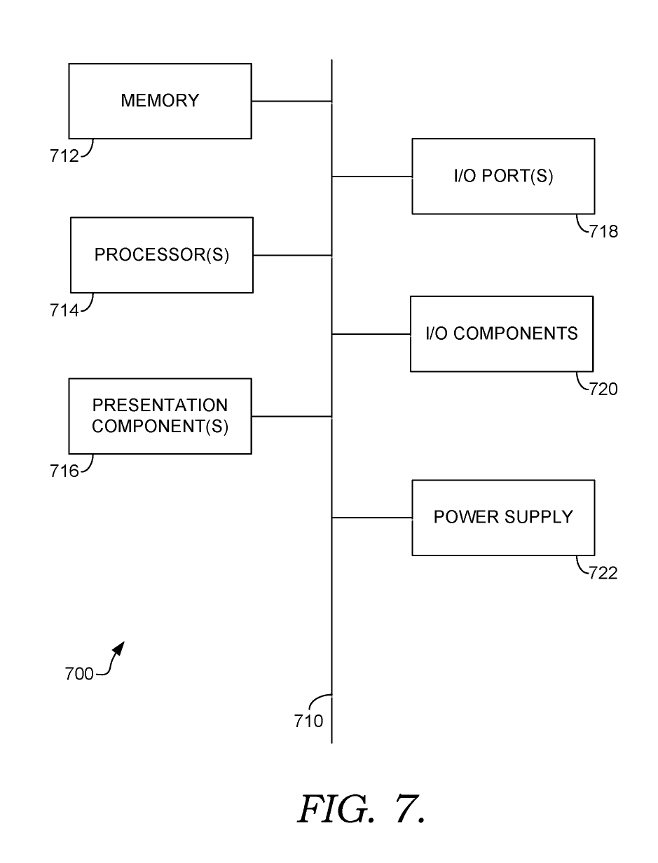

Having described implementations of the present disclosure, an exemplary operating environment in which embodiments of the present invention may be implemented is described below in order to provide a general context for various aspects of the present disclosure. Referring initially to FIG. 7 in particular, an exemplary operating environment for implementing embodiments of the present invention is shown and designated generally as computing device 700. Computing device 700 is but one example of a suitable computing environment and is not intended to suggest any limitation as to the scope of use or functionality of the invention. Neither should the computing device 700 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 7, computing device 700 includes bus 710 that directly or indirectly couples the following devices: memory 712, one or more processors 714, one or more presentation components 716, input/output (I/O) ports 718, input/output components 720, and illustrative power supply 722. Bus 710 represents what may be one or more busses (such as an address bus, data bus, or combination thereof). Although the various blocks of FIG. 7 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 7 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 7 and reference to “computing device.”

Computing device 700 typically includes a variety of computer-readable media. Computer-readable media can be any available media that can be accessed by computing device 700 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 700. Computer storage media does not comprise signals per se. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 712 includes computer storage media in the form of volatile and/or nonvolatile memory. The memory may be removable, non-removable, or a combination thereof. Exemplary hardware devices include solid-state memory, hard drives, optical-disc drives, etc. Computing device 700 includes one or more processors that read data from various entities such as memory 712 or I/O components 720. Presentation component(s) 716 present data indications to a user or other device. Exemplary presentation components include a display device, speaker, printing component, vibrating component, etc.

I/O ports 718 allow computing device 700 to be logically coupled to other devices including I/O components 720, some of which may be built in. Illustrative components include a microphone, joystick, game pad, satellite dish, scanner, printer, wireless device, etc. The I/O components 720 may provide a natural user interface (NUI) that processes air gestures, voice, or other physiological inputs generated by a user. In some instance, inputs may be transmitted to an appropriate network element for further processing. A NUI may implement any combination of speech recognition, touch and stylus recognition, facial recognition, biometric recognition, gesture recognition both on screen and adjacent to the screen, air gestures, head and eye-tracking, and touch recognition associated with displays on the computing device 700. The computing device 700 may be equipped with depth cameras, such as, stereoscopic camera systems, infrared camera systems, RGB camera systems, and combinations of these for gesture detection and recognition. Additionally, the computing device 700 may be equipped with accelerometers or gyroscopes that enable detection of motion.

As described above, implementations of the present disclosure relate to devices for, among other things, assessing compliance with rehabilitation exercise programs. The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. One or more computer storage media storing computer-useable instructions that, when executed by a computing device, cause the computing device to perform operations, the operations comprising:
identifying a type of fitness activity to be performed by a user;
receiving biometric data from one or more biometric sensors while a user performs the fitness activity;
receiving motion data from one or more motion sensors while the user performs the fitness activity;
generating activity data for the fitness activity by correlating the biometric data with the motion data over time; and
generating compliance data by comparing the activity data for the fitness activity with a biometric signature for the user for the type of fitness activity.

2. The one or more computer storage media of claim 1, wherein the one or more biometric sensors comprise one or more selected from the following: a heart rate monitor; and a breathing rate monitor.

3. The one or more computer storage media of claim 1, wherein the one or more motion sensors comprise one or more selected from the following: an accelerometer; a gyroscope; and an inertial measurement unit (IMU).

4. The one or more computer storage media of claim 1, wherein the one or more biometric sensors and the one or more motion sensors are located on a single device.

5. The one or more computer storage media of claim 1, wherein the one or more biometric signatures and one or more motion sensors are located on a plurality of devices.

6. The one or more computer storage media of claim 5, wherein the plurality of devices include a personal device worn by the user and an equipment device attached to fitness equipment used by the user to perform the fitness activity, wherein the personal device includes at least one of the one or more biometric sensors and the equipment device includes at least one of the one or more motion sensors.

7. The one or more computer storage media of claim 6, wherein the personal device also includes at least one of the one or more motion sensors.

8. The one or more computer storage media of claim 1, wherein the computing device comprises a user device or server device that is separate from the one or more biometric sensors and the one or more motion sensors.

9. A computer-implemented method, the method comprising:
identifying a type of fitness activity to be performed by a user;
receiving biometric data with time data, the biometric data from one or more biometric sensors while a user performs the fitness activity;
receiving motion data with time data, the motion data from one or more motion sensors while the user performs the fitness activity;
generating activity data for the fitness activity by correlating the biometric data with the motion data using the time data associated with biometric data and the time data associated with the motion data; and
generating compliance data by comparing the activity data for the fitness activity with a biometric signature for the user for the type of fitness activity.

10. The method of claim 9, wherein the one or more biometric sensors and the one or more motion sensors are located on a single device.

11. The method of claim 9, wherein the one or more biometric signatures and one or more motion sensors are located on a plurality of devices.

12. The method of claim 11, wherein the plurality of devices include a personal device worn by the user and an equipment device attached to fitness equipment used by the user to perform the fitness activity, wherein the personal device includes at least one of the one or more biometric signatures and the equipment device includes at least one of the one or more motion sensors.

13. The method of claim 12, wherein the personal device also includes at least one of the one or more motion sensors.

14. A computer system comprising:
a biometric sensor that collects biometric data from a user during a fitness activity;
a motion sensor that collects motion data during the fitness activity;
an activity tracking module that generates activity data for the fitness activity using the biometric data from the biometric sensor and the motion data from the motion sensor; and
a compliance module that generates compliance data based on the activity data and a biometric signature for the user for a type of fitness activity corresponding to the fitness activity.

15. The system of claim 14, wherein the biometric sensor comprises one or more selected from the following: a heart rate monitor; and a breathing rate monitor.

16. The system of claim 14, wherein the one or more motion sensors comprise one or more selected from the following: an accelerometer; a gyroscope; and an inertial measurement unit (IMU).

17. The system of claim 14, wherein the biometric sensor, motion sensor, activity tracking module, and compliance module are provided on a single device.

18. The system of claim 14, wherein the biometric sensor, motion sensor, activity tracking module, and compliance module are distributed on a plurality of devices.

19. The system of claim 18, wherein the plurality of devices include a personal device worn by the user and an equipment device attached to fitness equipment used by the user to perform the fitness activity, wherein the personal device includes the biometric sensor and the equipment device includes the motion sensor.

20. The system of claim 19, wherein the personal device also includes a second motion sensor.
